(19) United States
(12) Patent Application Publication
(10) Pub. No.: US 2026/0249667 A1
(43) Pub. Date: Aug. 27, 2026

(54) IMPACT ABSORBING STRUCTURES AND METHODS OF MANUFACTURING

(71) Applicant: PLASAN SASA LTD., Kibbutz Sasa (IL)

(72) Inventors: Avi Migdal, Shlomi (IL); Vadim Favorsky, Maalot-Tarshiha (IL); Felix Aizik, Kibbutz Sasa (IL)

(21) Appl. No.: 19/447,719

(22) Filed: Jan. 13, 2026

Related U.S. Application Data
(63) Continuation-in-part of application No. 17/428,747, filed on Feb. 17, 2020, now abandoned.
(60) Provisional application No. 62/808,311, filed on Feb. 21, 2019.

(51) Int. Cl. B60J 5/04; B32B 1/08; B32B 5/02; B32B 5/26; B32B 7/022; B62D 29/00

(52) U.S. Cl. CPC B60J 5/0444; B32B 1/08; B32B 5/024; B32B 5/263; B32B 7/022; B62D 29/00; B32B 2262/0269; B32B 2262/106; B32B 2307/558; B32B 2605/00

(57) ABSTRACT

An impact-resisting beam is provided, the beam comprising a multi-layer composite structure, the composite structure comprising first and second fibrous materials, the first fibrous material having a first effective elastic modulus and comprising one or more layers comprising fibers of a first type being arranged with one or more orientation angles relative to a longitudinal axis of the beam such that a predetermined load applied to the beam from a direction perpendicular to its longitudinal axis drives the fibers of the first type towards alignment with the longitudinal axis of the beam, the second fibrous material having a second effective elastic modulus and comprising one or more layers comprising fibers of a second type, the second fibrous material being selected to provide effective elongation or deformation of the beam which prevents splitting of the beam under application of the predetermined load.

### TECHNOLOGICAL FIELD

The present invention is in the field of composite materials and composite structures for impact energy absorbance and/or resistance. In particular, the invention is exemplified with anti-intrusion beam for use in a vehicle.

### BACKGROUND

Metals are generally known for their hardness and ductility making them suitable for withstanding high impact without failing or breaking apart. On the other hand, metals are relatively heavy making them less suitable for applications where lightness is desirable. Composite materials are widely used to achieve desirable material characteristics not available when taking each of the composite material’s constituents alone. Combining one or more materials can produce a material with properties different from the individual constituents. The new composite material may be preferred for many reasons such as being stronger, lighter, or less expensive when compared to traditional materials.

In today’s high requirements for safety as well as energy consuming reduction, highly strong and light materials are desired in the transportation field. This allows less fuel consumption while increasing safety of passengers.

For example, in KR20140016688 an impact beam for a car door is described. The beam includes a hollow inner layer configured to have a structure of laminated carbon fiber prepregs, and an outer layer configured to have a structure of laminated aramid fiber-containing prepregs on the hollow inner layer. The document mentions advantages of the described structure as being light-weight and having excellent vibration damping properties, thereby improving the impact resistance.

In KR20140123245, filed later by the same applicant of the above-mentioned application, another impact beam for a vehicle door is described; the beam includes an inner hollow metal rod, a fiber reinforcing layer laminated on the hollow metal rod and an outermost layer with aramid braid prepregs laminated on the reinforcing layer. It is stated again that this structure has a good vibration reducing capability, high impact-resistance, improved elasticity and reduced weight.

### GENERAL DESCRIPTION

The present invention provides a novel composite material possessing various desired properties such as durability, lightness, strength, scalability and relatively ease of manufacture. Using the composite material of the invention as an essential part of a product allows flexibility in the design of the product in order to meet required parameters or qualities of the product.

The present invention is specifically exemplified in connection with a vehicle anti-intrusion beam (occasionally called herein “door beam”) comprising the composite material of the invention. Specifically, the beam can be built only by using composite materials that include the composite material of the invention. In contrast to door beams made basically from metal or including metal as a major or minor part thereof, producing a door beam based ultimately on composite materials and specifically the composite material of the invention allows the door beam to be highly strong and impact-resisting while being significantly lighter, thereby increasing safety of passengers while saving energy and enhancing green applications by reducing fuel-consumption.

Apart from being as much as possible light-weight and sufficiently rigid, design of the optimal anti-intrusion beam should take into account other factors, such as space restrictions, i.e. maximum volume of the beam being governed by the design (shape and/or overall dimensions) of the vehicle in general and its doors in particular.

In order to fulfill the required rigidity and overall dimensions, it might be inevitable to include metal as one or sole component of the beam structure, because metal is rigid and while having a relatively small thickness to obtain a required stiffness and toughness. However, as mentioned earlier, using metal sacrifices the lightness requirement which is becoming significantly important recently either in fuel- or electric- operated vehicles. Therefore, it would be advantageous to build an anti-intrusion beam made from composite, light, materials while insuring the required stiffness and impact resistance and/or absorbance.

The present invention enables to achieve the above listed goals, inter alia, light weight, desired hardness, desired toughness and small dimensions. The present invention allows optimizing the composite structure properties to specific load conditions and functional requirements. Adjusting fiber layers thicknesses and orientations can significantly affect the mechanical behavior, e.g. improve the stiffness, hardness, energy absorption, and change failure kinematics. Numerical methods and tools can help achieve the optimal design of composite’s layup. According to results of optimization, a transversely loaded door beam shows better energy absorption values when it has non-zero oriented fibers with respect to the longitudinal axis of the beam. This result of the invention can be explained by more extensive and at the same time more slow damage development in the layers containing non-zero oriented fibers.

Thus, according to one broad aspect of the present invention there is provided an impact-resisting beam comprising a multi-layer composite structure, the composite structure comprising:

a first fibrous material having a first effective elastic modulus, the first fibrous material comprising one or more layers comprising fibers of a first type being arranged with one or more orientation angles relative to a longitudinal axis of the beam, such that a predetermined load applied to the beam from a direction substantially perpendicular to its longitudinal axis drives the fibers of the first type towards alignment with the longitudinal axis of the beam; and

a second fibrous material having a second effective elastic modulus, the second fibrous material comprising one or more layers comprising fibers of a second type, the second fibrous material being selected to provide effective elongation of the beam which prevents splitting of the beam under application of the predetermined load.

Under a predetermined force applied to the beam, when the force has at least one vector in a direction perpendicular to the longitudinal axis of the beam, the beam is designed to absorb the impact energy of the predetermined force while not breaking or failing. The second fibrous material, with its elongation properties, is configured to maintain the integrity and oneness of the beam. So, the second fibrous material has good (sufficient) elongation properties to insure that the composite structure does not split or fall apart when bending or twisting under the predetermined force. The second fibrous material may have a relatively low Young’s Modulus enabling it to suitably deform under the predetermined load.

The first fibrous material is oriented with respect to the longitudinal axis of the beam and to the force direction as well. This enables extra energy absorbance and impact withstanding such that a first portion of the impact energy is used in aligning the fibers with the beam’s longitudinal axis direction while a second portion of the impact energy is resisted by the stiffness qualities of the fibers. Therefore, the first fibrous material is selected with enough toughness to withstand a predetermined impact force. In a world where saving energy is becoming a priority, the oriented fibers structure enables using less material, thus saving weight, in comparison to traditional structures in which the fibers are oriented along the longitudinal axis, while even enabling resistance of higher loads since one portion of the load’s energy is used in sliding/translating/moving the fibers towards alignment with the longitudinal axis and only after alignment a second portion of the load’s energy is absorbed by the elongation and stiffness properties of the first type fibers.

In some embodiments, the multi-layer composite structure additionally comprises a third fibrous material having a third effective elastic modulus, the third fibrous material comprising one or more layers comprising fibers of a third type being arranged in the direction of the longitudinal axis of the beam.

The third fibrous material is generally aligned with the longitudinal axis of the beam and is selected to be stiff enough to absorb as much as possible portion of the impact energy before failure or fracture. Accordingly, utilizing the third fibrous material can be advantageous in scenarios where the predetermined resistible load is very high. Generally, due to a relatively high Young’s modulus, the fibers of the third fibrous material do not deform to a large extent and may break under the predetermined load and by this absorb a major portion of the whole impact energy.

In some embodiments, the fibers of the first and second, and optionally- provided third, fibrous materials are bonded with one or more resin materials.

In some embodiments, the first effective elastic modulus is lower than the third effective elastic modulus.

In some embodiments, the fibers of the first and third types are identical in at least their shape, volume or composition.

In some embodiments, the second effective elastic modulus is lower than each of the first and third effective elastic modulus.

In some embodiments, the second fibrous material has an elongation property being larger than elongation of each of the first and third fibrous material.

In some embodiments, the second fibrous material is located at outermost side of the composite structure.

In some embodiments, the first fibrous material is located at innermost side of the composite structure.

In some embodiments, the third fibrous material is located between the first and second fibrous materials, and the relation between the first, second and third effective elastic modulus is selected such that under application of the predetermined load the third fibrous material absorbs major part of impact energy of the predetermined load resulting in at least some of the fibers of the third type splitting or breaking.

In some embodiments, a transverse cross section of the beam is isotropic.

In some embodiments, a transverse cross section of the beam is anisotropic.

In some embodiments, a transverse cross section of the beam has an open shape.

In some embodiments, a transverse cross section of the beam is circular and each of the fibrous materials is formed as a full ring.

In some embodiments, a transverse cross section of the beam is quadrangular.

In some embodiments, a transverse cross section of the beam is quadrangular and wherein:

two parallel sides of the quadrangle are formed with the first, second and third fibrous materials, and

other two parallel sides of the quadrangle are formed with the first and second fibrous materials.

In some embodiments, the orientation angles have absolute values in a range of between 1^{o} and 45^{o} with respect to the longitudinal axis of the beam.

In some embodiments, the first and/or third fibrous materials comprise woven or non-crimp fabrics.

In some embodiments, the second fibrous material comprises woven fabric.

In some embodiments, the fibers of first and/or third type are made from carbon.

In some embodiments, the fibers of second type are made from aramid.

In some embodiments, the beam is configured for use as a door beam in a vehicle.

In some embodiments, the beam is fabricated using pultrusion process.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a non-limiting example of a beam configured according to embodiments of the present invention;

FIG. 2 illustrates another non-limiting example of a beam configured according to embodiments of the present invention;

FIGS. 3A-3D illustrate non-limiting examples of a fibrous material for use in a beam of the present invention; and

FIGS. 4A-4D illustrate non-limiting examples of the transverse cross section of the beam of the present invention.

### DETAILED DESCRIPTION OF EMBODIMENTS

According to one of its aspects, the present invention provides a multi-layer composite structure, the composite structure comprising:

a first fibrous material having a first effective elastic modulus, the first fibrous material comprising one or more layers comprising fibers of a first type being arranged with one or more orientation angles relative to a longitudinal axis of the beam, such that a predetermined load applied to the beam from a direction substantially perpendicular to its longitudinal axis drives the fibers of the first type towards alignment with the longitudinal axis of the beam; and

a second fibrous material having a second effective elastic modulus, the second fibrous material comprising one or more layers comprising fibers of a second type, the second fibrous material being selected to provide effective elongation of the beam which prevents splitting of the beam under application of the predetermined load.

According to another broad aspect, the invention provides an impact-resisting beam comprising the multi-layer composite structure. In particular, the impact resisting beam can be configured as an anti-intrusion beam for use in a vehicle.

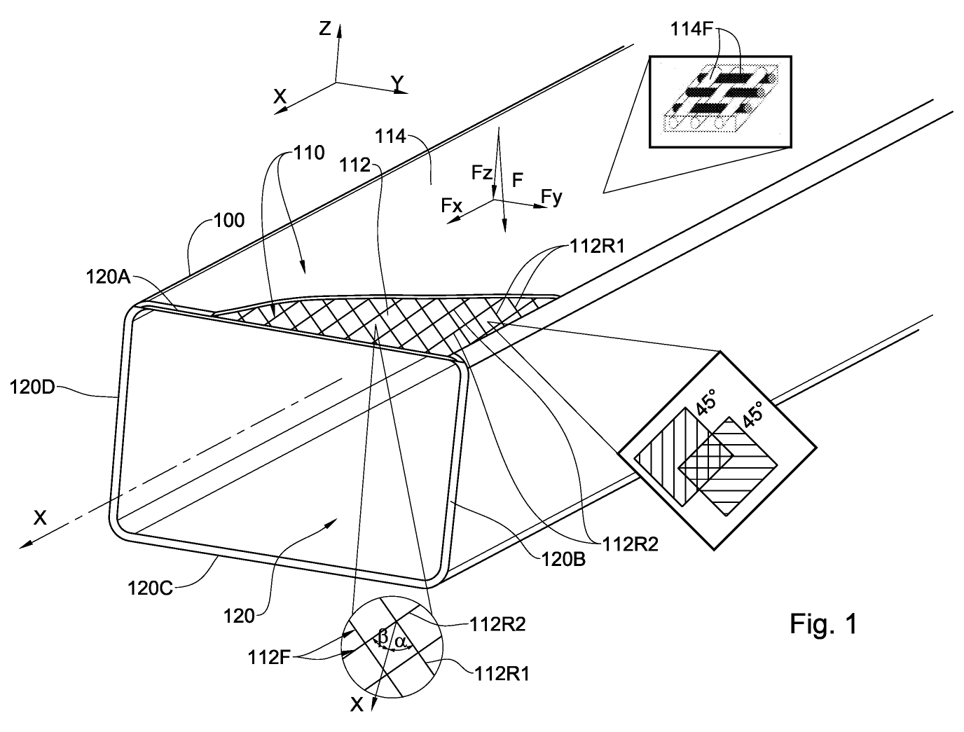

Reference is made to FIG. 1 showing an exemplary non-limiting embodiment of an impact-resisting beam 100 that includes a multi-layer composite structure 110 configured in accordance with exemplary embodiments of the present invention. As shown, the beam 100 extends along an axis X (occasionally called a longitudinal axis) in the x-direction (may also be called the zero direction). Also shown is a force F acting on the beam 100 substantially in the negative z-direction, i.e. it has a component in the z-direction, F z, and it can generally also have components in the x and y directions, F x and F y. The expression "substantially", as used herein, can be interpreted as that the major portion of the quantity (for example, at least 50%) behaves as described. For example, a force is substantially acting in a specific direction (z, for example), this means that the force component in the specific direction is larger than each of the components in the other two directions (x,y).

The beam has a cross section 120 in the yz plane (occasionally called the transverse cross section), i.e. in the perpendicular direction to its longitudinal axis X. The cross section of the beam can be configured as full or hollow. In some embodiments, the cross section is hollow, thus helping, inter alia, in keeping the weight as low as possible. The transverse cross section can be configured in a variety of geometrical shapes, as will be further exemplified and detailed below, and accordingly the beam 100 has one or more sides forming the geometrical shape of the cross section. The geometrical shape of the transverse cross section can be a closed shape such as a polygon, either having identical or different sides and/or angles between the sides. Alternatively, the geometrical closed shape of the transverse cross section can be a circle or an ellipse or another shape of curved line(s). In some embodiments, the transverse cross section is an open shape, i.e. it does not have a perimeter and it extends between first and second different spatial points. Generally, the cross section’s geometrical shape can be selected in accordance with the desired/required impact-resisting, mechanical, properties of the beam as well as in accordance with the available space in which the beam is positioned. In the shown example, the cross section 120 is configured with four sides 120A, 120B, 120C and 120D, forming a quadrangle. In specific non-limiting embodiments, the quadrangle can be configured as a rectangle or as a square. In the described non-limiting example, the cross section 120 is configured as having a rectangular shape, which more specifically can be a square. The sides 120B and 120D have an important role in the resistance to bending under an impact of the force F and particularly its component F z. The length as well as the depth of the sides 120B and 120D can be selected to enhance the beam’s resistance to bending, where longer and deeper sides provide higher bending resistance.

Generally, the impact-resisting beam of the invention has at least one side that includes the composite structure, such as the side 120A in the described example that includes the composite structure 110. The beam side(s) that include(s) the composite structure (e.g. side 120A) is at least the side on which the force F acts directly. In some embodiments, the beam can be configured with more than one side that include the composite structure. In one example, the beam may include two opposite sides that include the composite structure. In another example, all the beam sides may include the composite structure. In the specifically described non-limiting example, the side 120A includes the composite structure 110. It is possible though that the facing side 120C may be additionally configured to include the composite structure 110 or all the four sides 120A – 120D may be configured to include the composite structure 110. The specific design depends, inter alia, on the desired or required mechanical and impact-resisting properties of the beam and/or on the predetermined bearable impact load F.

The beam of the invention can be formed by separate sides bound together at the corners/edges there between. This enables using different (or similar) sides of different (or similar) composite materials. Alternatively, the beam can be formed by one material, specifically the composite structure of the invention, rolled up or wrapped in a predetermined manner along the whole perimeter of the transverse cross section to give a desired cross section shape. Yet alternatively, the beam can be formed by more than one material, including the composite structure of the invention at one side of the beam at least, arranged in sequence and rolled up or wrapped in a predetermined manner to give a desired cross section shape and composition. In the described example of FIG. 1, the beam is formed with at least the side 120A configured with the composite structure 110. However, it should be understood, that the beam can be configured with all the sides configured with the composite structure 110. In the latter specific example, the beam can be formed from a continuous surface of a single ply of the composite structure rolled up or wrapped for 360^{o} to form the quadrangular shape, or it can be formed from two plies of the composite structure connected at one edge such that each ply forms one, two or three sides and the other ply forms the remaining side(s), or it can be formed from three or four separate plies connected in sequence to form the sides 120A-120D. Importantly, as said before, the side that directly faces the impact force F (e.g., the side 120A) is formed with the composite structure 110.

The composite structure of the invention extends typically along the whole length of one or more beam sides (e.g. in the x-direction) and may extend across the whole width of the beam side or across a portion of the beam side’s width (e.g. in the y direction). In the described example, the beam side 120A includes the composite structure 110 along and across its whole length and width respectively.

The composite structure of the invention includes at least two different fibrous material kinds, formed in at least two respective stacked layers, each giving the composite structure one or more distinguished mechanical property(ies), such as elongation, strength and energy absorption properties. In some embodiments, as will be further exemplified below, the composite structure includes one or more layers of each of the at least two fibrous material kinds. In some embodiments, the composite structure includes two or more stacked layer groups, where each layer group is formed by the at least two different fibrous material kinds (formed in at least two respective layers) stacked together.

The order of layers of the fibrous materials in the composite structure is not fixed to what is shown in the non-limiting examples of the figures. The fibrous materials can be arranged in any order that gives the desired mechanical property(ies) of the beam. In some embodiments, the second fibrous material is the material located on the far side with respect to the side/direction from which the impact load hits, in other words, the impact load impinges firstly on the first, and possibly the third (if existing, as will be described herein further below), fibrous materials and after all on the second fibrous material that prevents the splitting of the composite structure (the beam) under the predetermined impact load.

The fibers of each of the at least two fibrous materials of the side 120A can be arranged in one or more arrays (in the xy plane) one above the other (i.e. in the z-direction). Additionally, the fibers density can differ between the different arrays such that each array includes a different number of fibers typically arranged in a spaced- apart fashion.

The fibers can have a length or a projection (if it is inclined with respect to the longitudinal axis) that is equal to the longitudinal axis of the beam, or can have a shorter length such that a plurality of fibers are arranged one after another or one beside another in the direction of the longitudinal axis.

Accordingly, the mechanical properties of the beam including its toughness, strength, elongation (ductility) and others can be controlled by fibers’ properties, e.g. density, in each layer of each fibrous material, by number of layers of the fibrous materials or by the order of the layers (of different fibrous materials) in the composite structure.

The fibers in each fibrous material as well as the fibrous materials can be held together using resin or any other suitable adhesive material.

As shown in the non-limiting example of FIG. 1, the composite structure 110 includes two fibrous materials 112 and 114 stacked together. The first fibrous material 112, which is the lower, inner, layer in this example, has a first effective elastic modulus (Young’s modulus) and includes fibers of a first type 112F being arranged in two arrays in the xy plane, 112R1 and 112R2, with respective two or more orientation angles, such as α and β, relative to the longitudinal axis X of the beam. Specifically, in the described example, the angles are chosen as +45 o and -45 o as will be described further below.

The fibers in the two arrays 112R1 and 112R2 can be separate such that each array is located in a specific z level (e.g., a specific layer) or can be woven, for example crossed or threaded.

It should be noted that the expression “effective” elastic modulus, used herein through the present disclosure, means the overall, collective, elastic modulus of the specific fibrous material composition, whether the fibrous material is configured with one or more layers and wherein each layer is configured with a specific fiber density or kind. The plain expression of elastic modulus can be used to describe the property of the single fiber or single layer, as the case may be. Furthermore, it should be noted that the expressions elastic modulus, stress-strain-modulus and young’s modulus are used through the application interchangeably meaning the same mechanical property of the material.

The one or more orientation angles cause that a predetermined load applied to the beam from a direction other than the longitudinal axis’s direction, e.g. being a direction perpendicular or substantially perpendicular to the longitudinal axis of the beam drives the fibers of the first type 112F towards alignment with the longitudinal axis of the beam. When a beam is subjected to an impact load in the substantially perpendicular direction to the beam’s longitudinal axis, the beam tends to bend and/or twist, causing the fibers to move and/or turn, thereby aligning with the general longitudinal axis direction.

The alignment movement of the fibers 112F when the beam 100, and more specifically the first fibrous material 112, is subjected to the load F, enables the beam to withstand a larger force than the force it can withstand without the fibers’ alignment process. A first portion of the impact energy of the force F is used, i.e. absorbed, in the alignment process of the fibers instead of being directly absorbed by the elongation of fibers when the latter are initially aligned with the longitudinal axis of the beam, thus increasing the bearable load by the beam. In other words, the fibers 112F start to slide, translate, rotate or move towards alignment with the longitudinal axis X when subjected to the impact load and a first portion of the impact energy of the force F is used for this. After the alignment of the fibers, a second portion of the impact energy of the force F is absorbed by the elongation of the fibers 112F. In this case, it is either that the fibers, or at least some of the fibers, can absorb the whole remaining impact energy of the force F, or that some of the fibers are broken during the impact energy absorption. The last behavior of the fibers depends on the force magnitude and/or momentum, as well as on the fibers characteristics and properties such as the material the fibers are made from.

It should be understood that for a specific kind of material of the fibers and specific structural design of the fibers (density, geometry, etc.), the orientation angle(s) play(s) an important role in defining the mechanical properties, of the composite structure and the beam, that determine the magnitude of the load F (when having its maximum impact, i.e. being perpendicular to the longitudinal axis of the beam), that its impact energy can be absorbed without causing the beam to fail mechanically. Varying the orientation angle(s) of the fibers is another degree of freedom that controls the mechanical properties of the composite structure (and the beam including it) and determines the magnitude of extra load that the composite structure (and the beam) can withstand in comparison to a composite structure that includes fibers aligned with the longitudinal axis. Specifically, larger angle(s) with respect to the longitudinal axis provide for a larger bearable impact force, as this enables larger value of the first portion of the impact energy that is used to align the fibers with the longitudinal axis.

As mentioned, more control on the mechanical properties of the composite structure, and the beam, can be achieved by exploiting more than one orientation angle in the same array of spaced-apart fibers as well as between the different arrays.

The fibrous material can be configured with one or more arrays of fibers, each array oriented with one or more orientation angle(s) with respect to the longitudinal axis of the beam. In the described example of FIG. 1, there are two arrays 112R1 and 112R2 having fibers oriented in +45 o and -45 o with respect to the longitudinal axis X, i.e. in both clockwise and anticlockwise directions. This specific symmetrical configuration of equal absolute angles, in opposite directions relative to the longitudinal axis, result in isotropic behavior and can potentially increase the stability of the beam both during the fabrication process and the impact-resisting action when being subject to an external load. However, the angles of the two arrays can be selected to be different to give the beam anisotropic behavior and directional properties, i.e. different properties in different directions as desired by the specific application. The angles magnitude can be different than 45^{o}, and can generally be in the absolute range between 1 and 45, while the decision about that is subject to the desired mechanical properties of the beam.

The second fibrous material 114 has a second effective stress-strain modulus (elastic modulus) and includes fibers of a second type 114F arranged in one or more arrays. The second fibrous material is selected to provide effective elongation of the beam which prevents splitting of the beam under application of a predetermined impact load. As mentioned above, the first and second fibrous materials can be configured with a plurality of layers and stacked together in a predetermined order to achieve desired mechanical properties of the beam. For example, the composite structure can be configured with two layers of each of the first and second fibrous materials stacked together in an alternating fashion. Preferably, with respect to the impact load direction, the last layer includes the second fibrous material and the first layer includes the first fibrous material.

The fibers of the second fibrous material can be arranged in a variety of configurations to achieve predetermined elongation property(ies) in one or more directions of the beam. Therefore, the non-splitting property of the beam, affected by the elongation properties of the fibers of the second fibrous material, can be isotropic or anisotropic depending on the specific application.

In some embodiments, the second fibrous material is a woven material. Specific examples of woven materials are described further below.

The second effective stress-strain modulus of the second fibrous material is often selected to be lower than the first effective stress-strain modulus of the first fibrous material. Therefore, the elongation of the second fibrous material is higher than the elongation of the first fibrous material, and the latter’s stiffness is higher than the former’s.

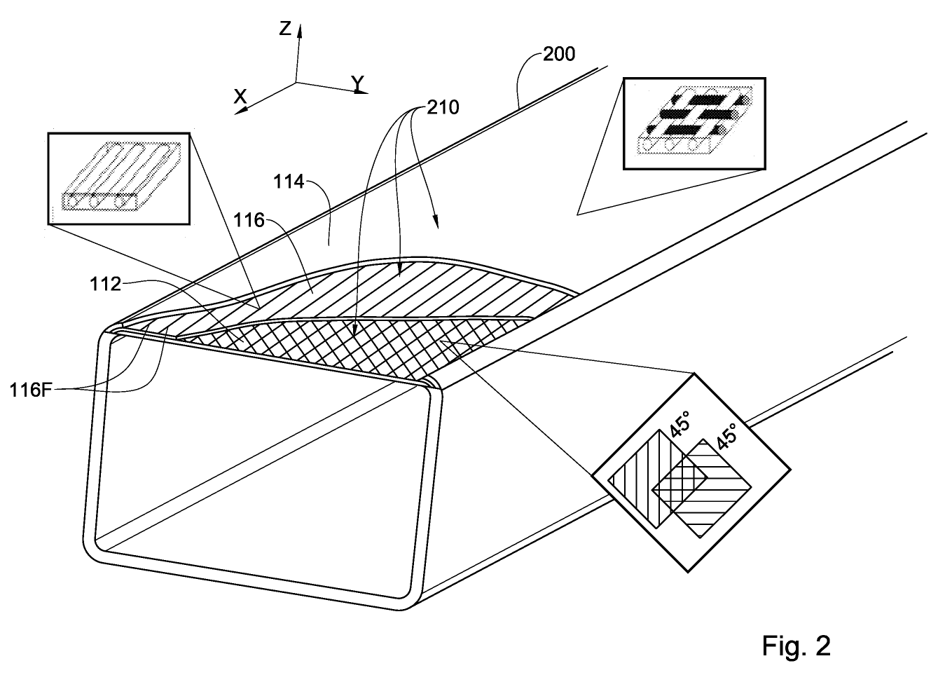

Reference is made to FIG. 2 showing an exemplary non-limiting embodiment of an impact-resisting beam 200 that includes a multi-layer composite structure 210 configured in accordance with exemplary embodiments of the present invention. As shown, the composite structure 210 includes three fibrous materials including the first and second fibrous materials 112 and 114 configured similarly to the composite structure 110. The properties and specifications of the fibrous materials 112 and 114 are the same as described above with respect to the exemplary embodiment of FIG. 1.

The composite structure 210 includes a third fibrous material 116 having a third effective elastic modulus and including fibers of a third type 116F being arranged in the direction of the longitudinal axis X of the beam 200. The third fibrous material can be configured as one or more layers and each layer can include one or more fiber arrays arranged, for example, one above another in the z direction (not shown).

The longitudinal fibers of the third fibrous material, as appreciated, have certain elongation property(ies) and certain stiffness property(ies). When the composite structure is exposed to an impact load, the longitudinal fibers of the third type 116F elongate as a first step, and break or deform as a second step depending on the fibers' mechanical properties.

Generally, the third fibrous material can be selected to absorb a major part of energy of the impact load, specifically when it is located between the first and second fibrous materials. In this situation, when subjected to a very high impact load, at least some of the fibers of the third type split or break to absorb a large portion of the impact energy. So, in the case of beam 200, the third fibrous material absorbs the major part of the energy, the first fibrous material absorbs a second lower portion of the impact energy in two stages, through the alignment stage and the elongation (and possibly breakage) stage, and the second fibrous material absorbs the lowest portion of the impact energy while maintaining the integrity and completeness of the beam. The inclusion of the third fibrous material can optimize the mechanical properties of the composite structure, and the beam, by achieving optimal lower overall weight with improved impact-resistance.

Other than the additional third fibrous material, the beam 200 can be configured similarly to the beam 100 as described above, e.g. with respect to the shape of the transverse cross section, the composition of each side of the transverse cross section being similar or different, or being made from one single material (the composite structure 210) or from a plurality of different composite materials extending along the whole perimeter of the cross section.

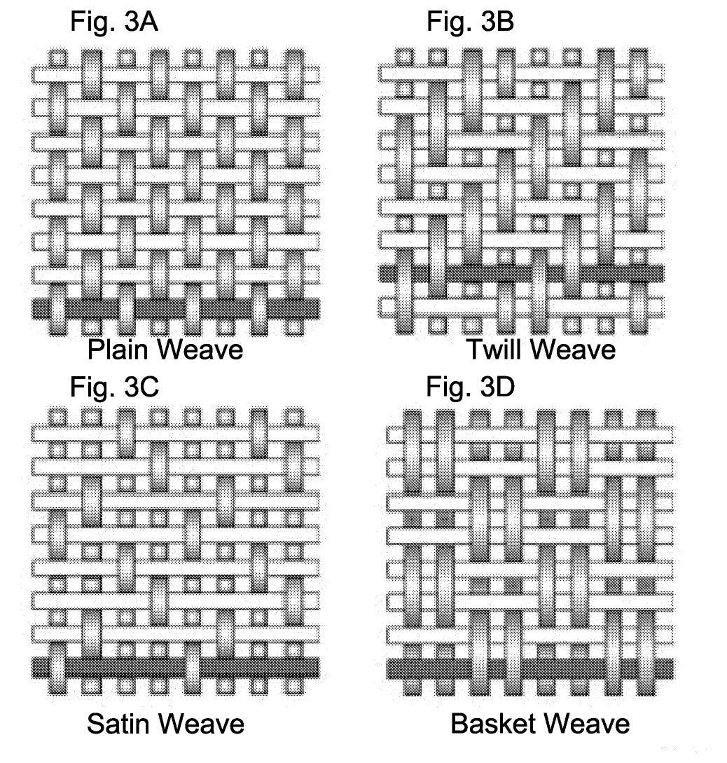

Reference is made to FIGS. 3A-3D illustrating non-limiting examples of the construction of the second fibrous material of the present invention. As mentioned above, the second fibrous material can be configured as a woven fabric, such as a plain weave, as shown in FIG. 3A, a twill weave, as shown in FIG. 3B, a satin weave, as shown in FIG. 3C, or a basket weave, as shown in FIG. 3D. It is appreciated that these aforementioned configurations are only some examples and the second fibrous material is not limited to those options, as long as the specific structure used meets the non-splitting condition under the specific predetermined impact load.

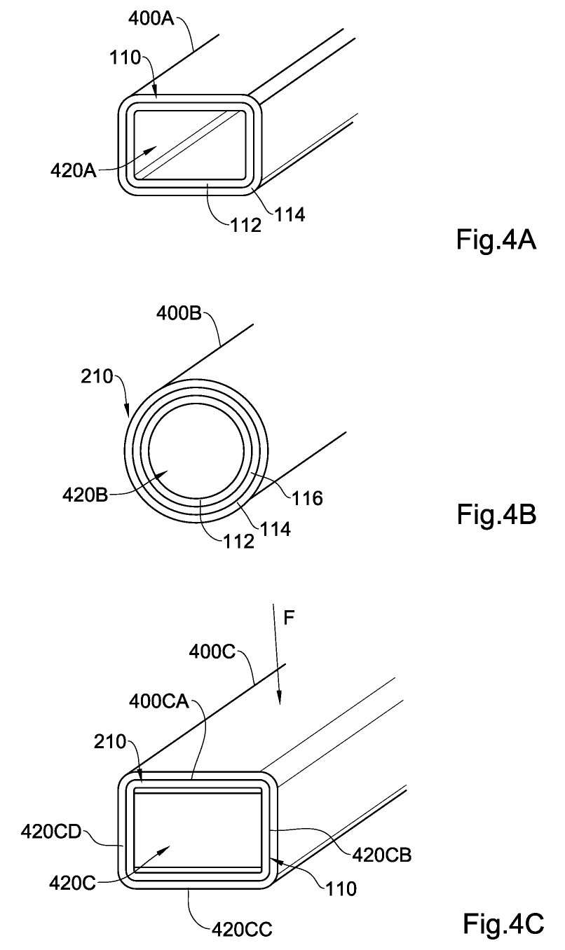

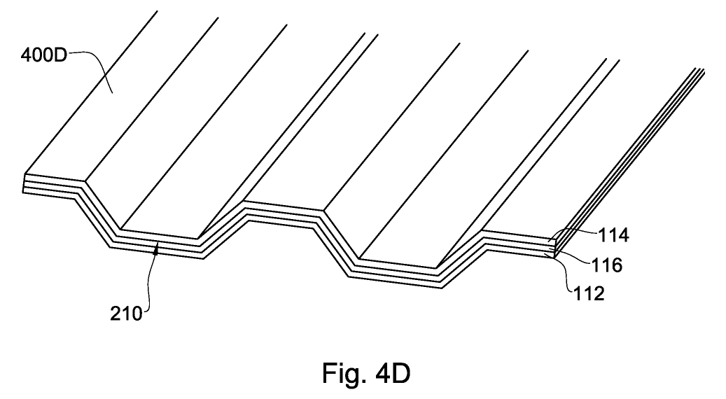

Reference is made to FIGS. 4A-4D illustrating non-limiting examples of the construction of the transverse cross section of the beam including the composite structure, such as 110 and 210, of the present invention.

FIG. 4A shows a quadrangle cross section 420A (e.g. rectangle or square) of a beam 400A including the composite structure 110 along the whole perimeter of the cross section. The composite structure 110 includes the first and second fibrous materials 112 and 114 on the inner and outer sides respectively. If the cross section’s geometry is a regular polygon, such as a square or an octagon, then the beam is isotropic and it behaves identically to a load oriented with same angle with respect to each side of the regular polygon. In the case the cross section’s geometrical shape is not a regular polygon, such as a rectangle, then the beam is anisotropic. The last configuration can be required or desired in certain circumstances according to space limitations or impact orientation with respect to the position and orientation of the beam. In particular, an anti-intrusion beam positioned inside a vehicle’s door is generally exposed to impact loads from certain directions only. Therefore, an anti-intrusion beam can be configured anisotropically.

FIG. 4B shows a beam 400B having a circular cross section 420B. The beam includes the composite structure 210 including the three fibrous materials 112, 114 and 116. As appreciated, the beam 400B is isotropic because of its cross section’s circular geometry as well as its common composition along the whole perimeter of the cross section 420B. However, if the cross section is elliptical, and the composite material is homogeneous along/across the perimeter, the beam would be anisotropic.

As shown in FIGS. 4A and 4B, the beam 400A or 400B may be formed of fibrous material and resin, such that the fibrous material and resin extend across the entirety of the thickness of walls of the beam. This provides the beam walls formed of fibrous material and resin (and optionally selected filler material) without additional elements of the walls. Further, the beam may include, or be covered with an external skin layer, e.g., paint layer.

FIG. 4C shows a beam 400C having a quadrangle cross section 420C. The beam 400C includes the composite structure 210 at its 420CA and 420CC facing sides, and the composite structure 110 at its 420CB and 420CD other facing sides. The sides 420CB and 420CD define the depth of the beam, when it is subjected to a force F in the z direction, i.e. substantially perpendicular to the sides 420CA and 420CC (and accordingly substantially parallel to the sides 420CB and 420CD). The depth of the beam, in the z direction, defines its resistance to bending caused by the force F, such that the larger the depth the larger the resistance. This proposed design of the beam 420C takes into account, for example, the demand for lowering the weight of the beam as much as possible. The sides which are parallel to the force direction (420CB and 420CD) can be configured with less degree of resistance to impact. Accordingly, a balance between weight and impact-resistance can be achieved when combining different composite structures, based on the specific application. In the example of FIG. 4C, the beam 420C is mechanically anisotropic even if the cross section’s geometry is a regular polygon, specifically a square.

FIG. 4D shows a beam 400D having an open-shape cross section. The beam 400D includes the composite material/structure 210, however though not specifically illustrated, a beam with an open-shape cross section can be configured with the composite material/structure 110. The open-shape can be chosen to provide sufficient resistance to a predetermined impact load, while keeping overall weight and/or volume of the beam low. Special open shapes known for their higher impact resistance can be used, such as the “W” open shape of the beam 400D. It should be noted that in the specific example of open cross section, the beam is arranged such that the second fibrous material is located on the far side with respect to the impact load direction, i.e. after the first ,and optionally third, fibrous material(s). For example, if used as an anti-intrusion beam in the vehicle door, the beam is positioned such that the inner layer (facing the inner side of the vehicle) is made from the second fibrous material, thereby preventing the split and preventing the broken fibers of the first and/or third fibrous material to fly towards the inside of the vehicle.

In some embodiments, the composite structures of the present invention can use carbon fibers in the first and/or third fibrous materials, or other fibers having similar mechanical properties, e.g. with respect to strength and stiffness. The carbon fibers can be provided as woven or non-crimp fabrics. Aramid fibers can be used in the second fibrous material, or other fibers having similar mechanical properties, e.g. with respect to elongation and elasticity. The aramid fibers can be provided as woven fabrics as described above with reference to FIGS. 3A-3D.

In some embodiments, the anti-intrusion beam of the invention is produced using a pultrusion technique, thus making its production easy and cost effective while providing the desired mechanical properties of the beam. Specifically, the production of the beam of the invention by pultrusion can be done in a single continuous process. The pultrusion parameters can be selected to generate a beam having the desired/predetermined mechanical properties as mentioned above. Pultrusion is a continuous process for manufacture of composite materials with constant cross-section. The term consists of "pull" and "extrusion". As opposed to extrusion, which pushes the material, Pultrusion works by pulling the material. In the standard Pultrusion process the reinforcement materials like fibers or woven or braided strands (or other form of fabrics) are impregnated with resin, possibly followed by a separate preforming system, and pulled through a heated stationary die where the resin undergoes polymerization. The impregnation is either done by pulling the reinforcement materials through a bath or by injecting the resin into an injection chamber which typically is connected to the die. Many resin types may be used in Pultrusion including but not limited to polyester, polyurethane, vinyl ester and epoxy. Resin provides, among others, the resistance to the environment (i.e., the corrosion resistance, the UV resistance, the impact resistance, etc.) and the glass provides strength.

As used herein, a pultrusion process refers to a continuous process for manufacturing composite structures having a pre-defined or generally constant cross section. The pultrusion process may be selected, modified, or tuned to meet processing requirements relating to one or more parameters associated with an end product, including material composition, physical dimensions, and target mechanical properties. A person of skill in the art will appreciate that known processing manipulations for pultrusion may be adapted for manufacturing the composite structures described herein.

In some embodiments, a pultrusion process for manufacturing an impact resisting beam and/or an anti intrusion beam utilizes one or more fibrous materials, optionally together with one or more additional filler materials, which are impregnated with at least one resin while being continuously pulled. The pulling strength may be selected to be compatible with mechanical characteristics of the fibrous materials. The process may be performed at a selected temperature and pulling rate, and optionally with other parameters selected to be compatible with chemical and or physical characteristics of the resin. The resulting resin impregnated fibers are shaped using a die, for example by pulling the impregnated fibers through a die having a desired cross-sectional profile, and the resin is cured to produce a pultruded composite beam.

Curing of the resin impregnated fibers may be performed by one or more of heating, UV radiation, or another curing technique. In some embodiments, heating is performed using an oven. In some embodiments, heating is performed using a heated die, for example by flowing a heated fluid through the die.

In some embodiments, the composite beam includes one or more internal cavities, and the pultrusion process further includes filling at least one of the cavities during manufacture. In some embodiments, the composite beam includes curvature characteristics, and the pultrusion process further includes applying one or more techniques to achieve the curvature characteristics.

1. A vehicle anti-intrusion beam, comprising:
a multi-layer composite structure including:
a first fibrous material having a first effective elastic modulus, the first fibrous material comprising one or more layers comprising fibers of a first type being arranged with one or more orientation angles having absolute values in a range of between 1° and 45° relative to a central longitudinal axis of the beam, such that a predetermined load applied to the beam from a direction perpendicular to the central longitudinal axis thereof drives the fibers of the first type towards alignment with the central longitudinal axis of the beam, the alignment of the fibers of the first type being responsible for absorbing a first portion of impact energy of the predetermined load; and
a second fibrous material having a second effective elastic modulus, the second fibrous material comprising one or more layers comprising fibers of a second type, the second fibrous material having elongation property that provides effective elongation or deformation of the beam which prevents splitting of the beam under application of the predetermined load,
wherein a cross section of the vehicle anti-intrusion beam is hollow, and wherein an innermost layer of the vehicle anti-intrusion beam defines the hollow and is formed of at least one of the first fibrous material or the second fibrous material, the composite structure is formed of the fibrous material and resin extending across an entirety of each wall of the beam and providing impact resistance to the entire width of each side of the beam.

2. The vehicle anti-intrusion beam according to claim 1, wherein the multi-layer composite structure further comprises a third fibrous material having a third effective elastic modulus, the third fibrous material comprising one or more layers comprising fibers of a third type being arranged in the direction of the central longitudinal axis of the beam.

3. The vehicle anti-intrusion beam according to claim 2, wherein the first effective elastic modulus is lower than said third effective elastic modulus.

4. The vehicle anti-intrusion beam according to claim 2, wherein the fibers of the first and third types are identical in at least one of their shape, volume, or composition.

5. The vehicle anti-intrusion beam according to claim 2, wherein the second effective elastic modulus is lower than each of said first and third effective elastic modulus.

6. The vehicle anti-intrusion beam according to claim 2, wherein the second fibrous material has the elongation property thereof being larger than elongation property of each of said first and third fibrous materials.

7. The vehicle anti-intrusion beam according to claim 2, wherein the third fibrous material is located between said first and second fibrous materials, and wherein relation between said first, second and third effective elastic modulus is selected such that under application of the predetermined load at least some of the fibers of the third type split or break resulting in that said third fibrous material absorbs a major part of the impact energy of the predetermined load.

8. The vehicle anti-intrusion beam according to claim 2, wherein the third fibrous material comprises woven or non-crimp fabrics.

9. The vehicle anti-intrusion beam according to claim 2, wherein the fibers of third type are made from carbon.

10. The vehicle anti-intrusion beam according to claim 2, wherein a transverse cross section of the beam is quadrangular and wherein:
two parallel sides of the quadrangle are formed with the first, second and third fibrous materials, and
other two parallel sides of the quadrangle are formed with said first and second fibrous materials.

11. The vehicle anti-intrusion beam according to claim 1, wherein the first fibrous material comprises woven or non-crimp fabrics.

12. The vehicle anti-intrusion beam according to claim 1, wherein the second fibrous material comprises woven fabric.

13. The vehicle anti-intrusion beam according to claim 1, wherein the fibers of first type are made from carbon and fibers of the second type are made from aramid.

14. The vehicle anti-intrusion beam according to claim 1, wherein a transverse cross section of the beam has one of the following properties: (a) the transverse cross section of the beam is isotropic, or (b) the transverse cross section of the beam is anisotropic.

15. The vehicle anti-intrusion beam according to claim 1, wherein a transverse cross section of the beam has one of the following shapes:
(a) the transverse cross section of the beam is circular and each of said fibrous materials is formed as a full ring, or
(b) the transverse cross section of the beam is quadrangular.

16. The vehicle anti-intrusion beam according to claim 1, wherein the first fibrous material is located at an outermost side of the composite structure and the second fibrous material is located at an innermost side of the composite structure.

17. The vehicle anti-intrusion beam according to claim 1, wherein the first fibrous material is located at an innermost side of the composite structure and the second fibrous material is located at an outermost side of the composite structure.

18. The vehicle anti-intrusion beam according to claim 1, being fabricated using a pultrusion process.

19. The vehicle anti-intrusion beam according to claim 18, wherein the beam is produced in a single continuous pultrusion process.

20. The vehicle anti-intrusion beam according to claim 18, wherein curing of resin-impregnated fibers is performed using a heated die by flowing a heated fluid through the die.
